(19) United States
(12) Patent Application Publication
(10) Pub. No.: US 2025/0000737 A1
(43) Pub. Date: Jan. 2, 2025

(54) SPINAL DECOMPRESSION APPARATUS, METHOD, AND SYSTEM

(71) Applicant: Timothy Martin Weeks, Medina, OH (US)

(72) Inventor: Timothy Martin Weeks, Medina, OH (US)

(21) Appl. No.: 18/342,359

(22) Filed: Jun. 27, 2023

(51) Int. Cl. A61H 1/02

(52) U.S. Cl. CPC A61H 1/0296; A61H 1/0218; A61H 2205/04

(57) ABSTRACT

An apparatus, a method, and a system for performing a rapid decompression thrust through the spinal fascia and dura through simultaneously applying a rapid tensile force on a first end portion or a spine, while a restraining force is simultaneously applied to a second, opposing end portion of the spine. The engagement points along the first and second end portions of the spine are formed through two strappings that engage, respectively, the skull and the pelvis of the patient. Each strapping provides handles for separate practitioners to manipulate when performing the spinal decompression thrust comprising one practitioner applying a rapid tugging tensile force, while the other practitioner securely holds or restrains the opposing end portion of the spine.

### BACKGROUND OF THE INVENTION

The present invention relates to spinal decompression and more particularly, to an apparatus, a method, and a system for performing a rapid spinal decompression thrust through the spinal fascia and dura of the patient.

Spinal decompression is the relief of pressure on the spinal cord or on one or more compressed nerve roots passing through or exiting the spinal column. Decompression of the spinal neural elements is a key component in treating spinal radiculopathy, myelopathy, and claudication. The compression manifests in the form of adhesion through the spinal facia and dura.

Fascia is a band or sheet of connective tissue, primarily collagen, beneath the skin that attaches to, stabilizes, encloses, and separates muscles and bones. Spinal dura mater (hereafter, “dura”), mesodermal in origin and arising from the meninx primitive, is a tightly woven, tubular membrane that encases the spinal cord along its length and partitions the central and peripheral nervous system.

Traction is offered as a non-surgical method of spinal decompression. Spinal traction as a means of spinal decompression is often applied without directly touching bones as other methods of traction do. To date, current spinal decompression systems do not attach to both skull and lower spine/pelvis at the same time for the purpose of a rapid decompression thrust through the spine and connective tissue.

A need exists for an apparatus, a method, and a system for performing a rapid spinal decompression thrust through the spinal fascia and dura, as the inventor has discovered, wherein the spinal decompression thrust includes applying a tensile force along a longitudinal direction to a first end portion of the spine while the opposing end portion of the spine is simultaneously restrained, wherein the application of tensile force and restraint is enabled through a strapping system.

### SUMMARY OF THE INVENTION

The present invention embodies a spinal compression apparatus providing a first strapping and a second strapping. The first strapping engages an upper portion of the patient's spine, while the second strapping engages a lower portion of the patient's spine, thereby defining first and second (upper and lower) spinal engagement points to those portions of the spine. The two spinal engagement points enable a spinal decompression thrust through applying a tensile force at one of the two spinal engagement points, while the other spinal engagement point is restrained.

The tensile force oriented in a longitudinal direction relative to the spine so as to stretch the spine. Both the simultaneous tensile force and restraint are performed by way of separate strapping, each strapping manipulated by a practitioner at or adjacent opposing ends of the patient's spine.

The two spinal engagement points may engage the skull and the pelvis of the patient, respectively. The first strapping may be a chinstrap with a handle on each of its two ends, for applying a first component of the spinal decompression thrust along the first/upper spinal engagement point at or adjacent the skull of the patient. The second strapping may include a waistband or pelvis-band with handles on each of its two ends for applying a second component of the spinal decompression thrust along the second/lower spinal engagement point at or adjacent the pelvis of the patient. The application of the tensile force be at the upper or lower end portion of the spine.

By performing a rapid decompression thrust simultaneously via the opposing first and second spinal engagement points that connects to the skull and pelvis, the adhesions through the connective tissue are removed and reduced.

In one aspect of the present invention, a method for applying a spinal decompression procedure to a patient, the method includes the following: securing a first strapping to a first end portion of a spine of the patient; securing a second strapping to a second end o portion of the spine of the patient; applying a tensile force by way of the first strapping, wherein a direction of the tensile force is substantially longitudinal relative to the spine; and restraining the second strapping against moving with the tensile force.

In another aspect of the present invention, the method for applying a spinal decompression procedure to the patient, further includes wherein the first end portion is a skull of the patient, and wherein the second end portion is a pelvis of the patient or wherein the first end portion is a pelvis of the patient, and wherein the second end portion is a skull of the patient; and further including wherein the first strapping is a chinstrap, wherein the second strapping is a pelvis strap wrapped at least once around the pelvis of the patient, wherein the first strapping has a handle of each of its two opposing ends, wherein the second strapping has a handle of each of its two opposing ends, wherein a first practitioner applies the tensile force by way of the handles of the first strapping, and wherein a second practitioner applies the restraint by way of the handles of the second strapping or wherein the second strapping is anchored to a fixed structure.

These and other features, aspects and advantages of the present invention will become better understood with reference to the following drawings, description, and claims.

### BRIEF DESCRIPTION OF THE DRAWINGS

FIG. 1 is a perspective view of an exemplary embodiment of the present invention, shown in use.

FIG. 2 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an apparatus, a method, and a system for performing rapid decompression thrust through the fascia and dura along the spine of the patient by simultaneously applying a rapid tensile force and a restraining force to both top end portion and bottom end portion of spine via a strapping system and two practitioners.

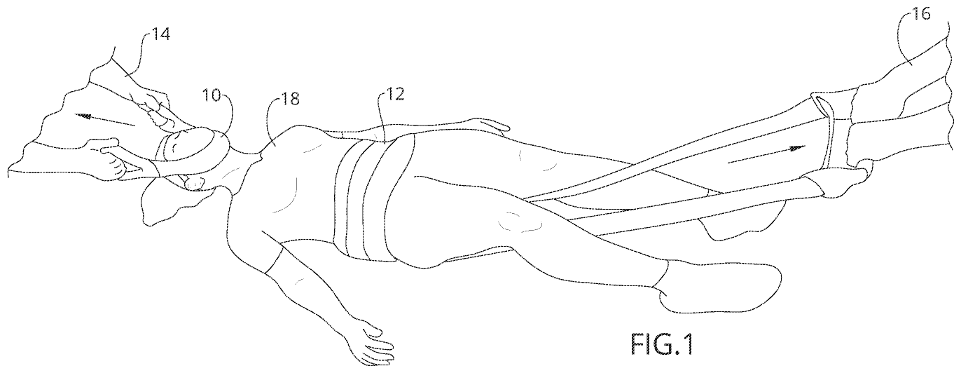

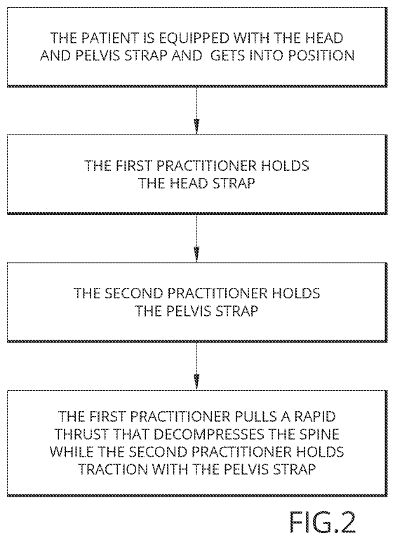

Referring to FIGS. 1 and 2, the present invention may include a method for applying spinal decompression thrust via a rapid tensile force while simultaneously applied a restraining force to opposing end portion of the spine. Each of an upper end portion and a lower end portion of the spine may be securely and safely engaged by way of systemic strapping. The spinal decompression thrust thus include a first component (longitudinal tensile force to a first end portion of the spine) and a simultaneously second component (restraining force to a second end portion of the spine).

The application of the rapid tensile thrust may be by way of two practitioners 14 and 16, the first practitioner 14 upward of the patient 18, or at least upward of the spine of the patient, and the second practitioner 16 proximate the patient 18, or at least downward of the spine of the patient 18.

A first strapping 10, which may be a chinstrap, engage the underside of the jaw of the patient 18. The first strapping 10 may have a handle on each opposing end for manipulation by the first practitioner 14. A second strapping 12, which may be a pelvis strap or waistband, wraps around the pelvis/waist of the patient 18. The second strapping 12 may have a handle on each opposing end for manipulation by the second practitioner 16.

The first strapping 10 secures the skull/head of the patient 18. The second strapping 12 secures pelvis and may attach bracing to some object so that the lower spine is held securely in place. The strapping system (the first and second strapping 10 and 12) securely braces the head and neck on one side and the pelvis on the other. Then a rapid thrust is made by the first practitioner 14 pulling the first strapping on the head and neck side, thereby superiorly lengthening the spine and connective tissue rapidly as the pelvic strap 12 securely holds the patient in place by way of the second practitioner 16 or a fixed structure.

The present invention may be made by sowing up a strapping system that securely buckles and attaches to the head and neck and pelvis. The strapping system with handles is essential. A mechanical device could be added later that performs the rapid decompression thrust. The decompression thrust could be made from the pelvis instead of from the head. The second strapping 12 could also alternatively be attached to the ankles instead of the pelvis.

Through application of the rapid spinal decompression thrust of the present invention, a solution to back pain, nerve issues, lack of mobility of the spine and connective tissue of a patient can finally be realized.

Additionally, the present invention could be used in veterinary medicine on animals.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A method for applying a spinal decompression procedure to a patient, the method comprising:
securing a first strapping to a first end portion of a spine of the patient;
securing a second strapping to a second end o portion of the spine of the patient;
applying a tensile force by way of the first strapping, wherein a direction of the tensile force is substantially longitudinal relative to the spine; and
restraining the second strapping against moving with the tensile force.

2. The method of claim 1, wherein the first end portion is a skull of the patient, and wherein the second end portion is a pelvis of the patient.

3. The method of claim 1, wherein the first end portion is a pelvis of the patient, and wherein the second end portion is a skull of the patient.

4. The method of claim 2, wherein the first strapping is a chinstrap.

5. The method of claim 4, wherein the second strapping is a pelvis strap wrapped at least once around the pelvis of the patient.

6. The method of claim 5, wherein the first strapping has a handle of each of its two opposing ends.

7. The method of claim 6, wherein the second strapping has a handle of each of its two opposing ends.

8. The method of claim 6, wherein a first practitioner applies the tensile force by way of the handles of the first strapping.

9. The method of claim 8, wherein a second practitioner applies the restraint by way of the handles of the second strapping.

10. The method of claim 6, wherein the second strapping is anchored to a fixed structure.
